(19) United States
(12) Patent Application Publication
(10) Pub. No.: US 2016/0098122 A1
(43) Pub. Date: Apr. 7, 2016

(54) DIGITIZER SENSOR

(71) Applicant: Microsoft Technology Licensing, LLC, Redmond, WA (US)

(72) Inventor: Arie GUR, Kiryat-Ono (IL)

(21) Appl. No.: 14/876,410

(22) Filed: Oct. 6, 2015

Related U.S. Application Data
(60) Provisional application No. 62/060,584, filed on Oct. 7, 2014.

(51) Int. Cl. G06F 3/044

(52) U.S. Cl. CPC G06F 3/044

(57) ABSTRACT

A sensor includes a sensing area confined by a plurality of edges and a plurality of antennas spread across the sensing area. The plurality of antennas cross each other to form a grid of junctions. The grid of junctions includes H*V junctions and wherein the plurality of antennas includes less than H+V antennas, wherein H is an integer number and V is an integer number.

### RELATED APPLICATION

This application claims the benefit of priority under 35 USC §119(e) of U.S. Provisional Patent Application No. 62/060,584 filed Oct. 7, 2014, the contents of which are incorporated herein by reference in their entirety.

### BACKGROUND

Capacitive sensors are used for position and proximity detection in many Human Interface Devices (HID) that include touch-screens such as laptops, trackpads, MP3 players, computer monitors, and smart-phones. Capacitive sensors sense positioning and proximity of a conductive object such as a conductive stylus or finger touch used to interact with the HID. Typically, capacitive sensors are sensitive both to the size and the proximity of the interacting object.

Capacitive sensors include electrodes that can be constructed from different media, such as copper, Indium Tin Oxide (ITO) and printed ink. ITO is typically used to achieve transparency. Some capacitive sensors are grid based and are operated to detect mutual capacitance between the electrodes at different points or junctions in the grid.

### SUMMARY

Typically, the resolution of a grid based capacitive sensor is defined by the number of junctions formed between row and column antennas. According to an aspect of some embodiments of the present disclosure there is provided a pattern for a grid based capacitive sensor that reduces the number of antennas needed to form a given number of junctions. According to some embodiments of the present disclosure, all of the antennas that form the grid extend from one edge of the sensor and connect via metal traces to circuitry from only that one edge. Optionally, the other edges of the sensor are free of metal traces and can extend toward an edge of an electronic display with substantially no black print area on at least three edges of the electronic display. The reduced number of antennas included in the pattern may reduce the cost and/or bill of materials of circuitry for operating the sensor.

According to an aspect of some embodiments of the present disclosure there is provided a touch screen formed with a plurality of independent grid based capacitive sensors that can be operated separately or together. In some exemplary embodiments, at least a portion the independent capacitive sensors include a pattern that provides for connecting to the sensing antennas from along one edge of the sensor. Optionally, the plurality of independent sensors may be arranged to form an oblong or large sensing area without compromising resolution and refresh rate.

Unless otherwise defined, all technical and/or scientific terms used herein have the same meaning as commonly understood by one of ordinary skill in the art. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIGS. 1A and 1B are simplified schematic drawings of a known and an exemplary grid pattern for a digitizer sensor respectively in accordance with some embodiments of the present disclosure;

FIG. 2 is simplified schematic drawing of an exemplary grid pattern for a digitizer sensor in a landscape configuration in accordance with some embodiments of the present disclosure;

FIGS. 3A and 3B are simplified schematic drawings identifying exemplary junctions of an exemplary grid pattern of a digitizer sensor receiving input and a numbering system for tracking movement across the digitizer sensor based on the inputs, all in accordance with some embodiments of the present disclosure;

FIG. 4 is a simplified schematic drawing of an exemplary grid pattern including sensing lines that improve resolution near edges of the sensing area in accordance with some embodiments of the present disclosure;

FIG. 5 is a simplified schematic drawing of an exemplary diagonal grid pattern with improved resolution along edges in accordance with some embodiment of the present disclosure;

FIG. 6 is a simplified schematic drawing of an exemplary grid pattern formed from a plurality of independent sensing sections in accordance with some embodiments of the present disclosure;

FIG. 7 is a schematic illustration of exemplary junctions for a grid pattern of a digitizer sensor in accordance with some embodiments of the present disclosure; and

FIG. 8 is a simplified block diagram of a digitizer system in accordance with some embodiments of the present disclosure.

### DETAILED DESCRIPTION

According to some embodiments of the present invention, a grid based capacitive sensor includes antennas that extend along a first direction, bend and then continue along a second direction. Optionally, the antennas extend from one edge of the sensor at an angle toward one of two neighboring edges and then bend away from the edge. Antennas that bend away from one edge cross with other antennas that bend away from the same edge or from an opposite edge to form a grid of junctions. Optionally, the antennas are an array of ‘L’ shaped antennas that cross each other. Junctions across an antenna can be formed on both sides of the bend. The additional antenna length afforded by the bend increases the number of junctions that can be formed with each antenna. Optionally, the pattern additionally includes a pair of antennas that extend along opposite edges of the sensing area to improve resolution near the edges. Optionally, a portion of the ‘L’ shaped antenna extends along one of the neighboring edges. Optionally, an antenna pattern is defined so that each antenna crosses most or all the other antennas once. The antennas may be patterned on a single layer using a one-glass solution including bridges that provide for capacitive coupling the antennas at the junctions.

Optionally, all the antennas of the sensor extend from one edge of a sensing area. Based on such an arrangement, a plurality of sensors can be placed side by side to establish a larger sensing area formed for a plurality of independent sensors. Optionally, the plurality of sensors can be operated in coordination to provide for seamless sensing across a full extent of the larger sensing area.

According to some embodiments of the present invention, the grid based capacitive sensor is suitable to detect fingertip input and the like with mutual capacitive detection. In some exemplary embodiments, during mutual capacitive detection, circuitry associated with the triggers or injects a signal on an antenna to initiate capacitive coupling at one or more junctions and samples capacitively coupled signals at the one or more other junctions. The triggering and the sampling of an antenna can occur at the same time. Optionally, all the antennas are both triggered and sampled. According to some embodiments, the grid based capacitive sensor is suitable to track an object, e.g. stylus based on signals emitted by object and detected by the sensor.

Before explaining at least one embodiment of the exemplary embodiments in detail, it is to be understood that the disclosure is not necessarily limited in its application to the details of construction and the arrangement of the components and/or methods set forth in the following description and/or illustrated in the drawings. The disclosure is capable of other embodiments or of being practiced or carried out in various ways.

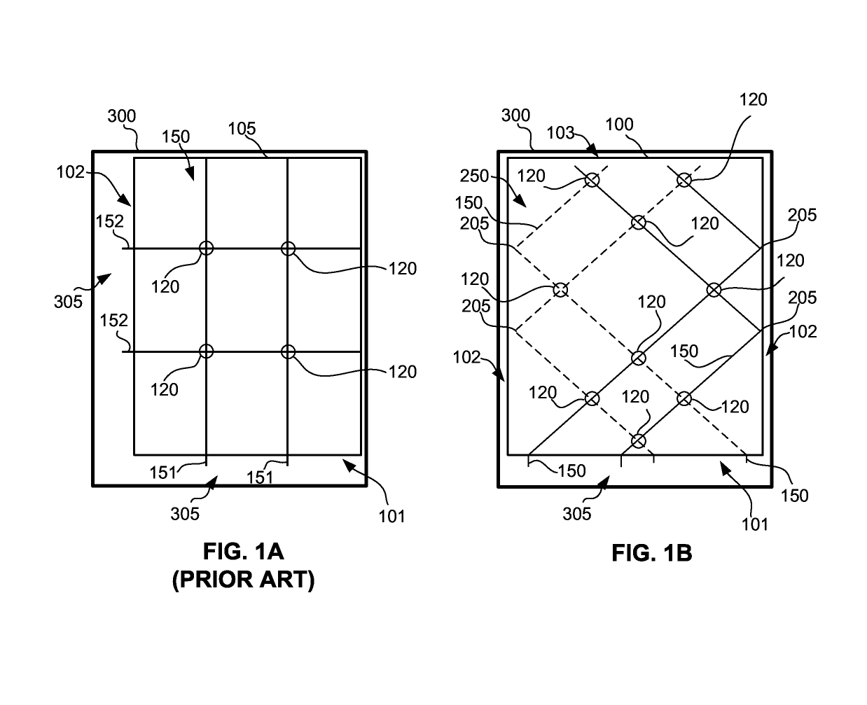

Reference is now made to FIGS. 1A and 1B showing simplified schematic drawings of a known grid pattern and an exemplary grid pattern for a digitizer sensor respectively in accordance with some embodiments of the present disclosure. Known grid based capacitive sensors include a pattern 150 with row antennas 152 and column antennas 151 that spread across a sensing area 105 and cross to form junctions 120. Row antennas 152 connect to circuitry from along edge 101 of sensing area 105 and column antennas 151 connect to circuitry from along edge 102 of sensing area 105. Typically sensing area 105 is narrowed as compared to a display panel area 300 to accommodate for connecting row antennas 152 along edge 102 and column antennas 151 along edge 101 to circuitry. Sensing area 105 may also typically be narrowed along facing edges for symmetry purposes. Typically, areas 305 along edge 101 and 102 are patterned with metal traces that connect the antennas to circuitry. Optionally, areas 305 are printed with black print to conceal the metal traces and/or circuitry.

During mutual capacitance detection, input at junctions 120 is detected by injecting a signal on antennas 152 one at a time and sampling output from column antennas 151. Alternatively, column antennas are triggered one at a time (by injecting a signal) and row antennas are sampled. The number of junctions provided by this grid pattern is defined by the number of rows antennas multiplied by the number of column antennas. Optionally, antennas 152 are triggered in groups with orthogonal signals. In the example shown in FIG. 1A, two row antennas and two column antennas provide four junctions. According to some embodiments of the present disclosure, an alternate pattern 250 is provided. Pattern 250 (FIG. 1B) includes four antennas 150 that provide nine junctions from which input can be detected based on mutual capacitance detection or self capacitance detection. The number of antennas in each of patterns 150 and 250 is the same although the resolution provided by pattern 250 is more than twice the resolution provided by pattern 150. Optionally, the number of junctions provide by pattern 250 is more than (N/2)̂2. Optionally, the number of junctions provided by pattern 250 is at least N*(N−1)/2 where N is the number of antennas 150. According to some embodiments of the present invention, all four antennas 150 extend from edge 101 and connect to circuitry from edge 101. Sensing area 100 can therefore extend to substantially a full width of display area 300. Area 305 accommodating metal tracing is only required along one edge, e.g. edge 101. In some exemplary embodiments, the number of antennas, N, used to form J junctions is N=ceiling((1+sqrt(1+8*J))/2).

In some exemplary embodiments, antennas 150 extend from edge 101 toward neighboring edges 102, form bends 205 and extend in another direction, e.g. toward edge 103. Typically, antennas 150 reflect off edges 102 and bends 205 occur along edges 102. An angle of antennas 150 typically depends on size and aspect ratio of sensing area 100. Antennas 150 are typically longer than antennas 151 and 152 and cross with more antennas. During mutual capacitive detection, each of antennas 150 is triggered with a signal, one at a time, and in response, all of the antennas are sampled. Typically, each antenna that is triggered is also sampled in response to triggering. Optionally, more than one antenna can be triggered at a time when triggering with orthogonal signals. Optionally, antennas are simultaneously triggered by injecting signals into antennas 150 with different frequencies and/or phases. When operating the sensor for self-capacitance detection, all antennas can be triggered and sampled simultaneously. Optionally, self-capacitance detection is performed on only a portion of antennas 150 at a time.

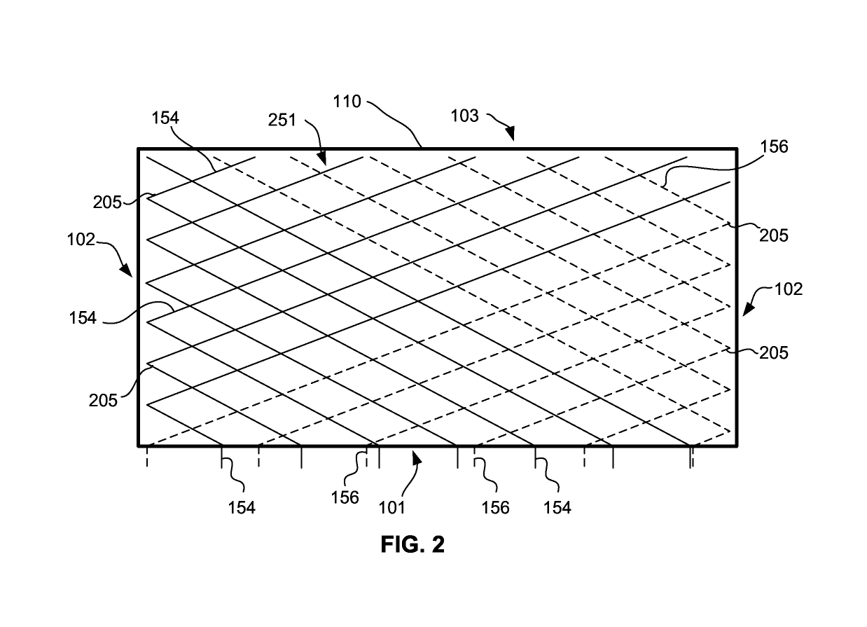

Reference is now made to FIG. 2 showing a simplified schematic drawing of an exemplary grid pattern for a digitizer sensor in a landscape configuration in accordance with some embodiments of the present disclosure. In some exemplary embodiments, a landscape pattern 110 includes a first array of antennas 156 extending from edge 101 to one of the neighboring edges 102 and bending toward edge 103 and a second array of antennas 154 extending from edge 101 to the other of the neighboring edges 102 and bending toward edge 103. Antennas from array 156 cross with other antennas from array 156 and also cross with antennas from array 154. Similarly antennas from array 154 cross with other antennas from array 154 and also cross with antennas from array 156. In the example shown, 13 antennas are patterned to provide more than 80 junctions. Typically, in a row and column grid, 18-20 antennas would be required to form 80 junctions. The reduction in the number of antennas is substantial and therefore less circuitry is required to support detection with such a sensor.

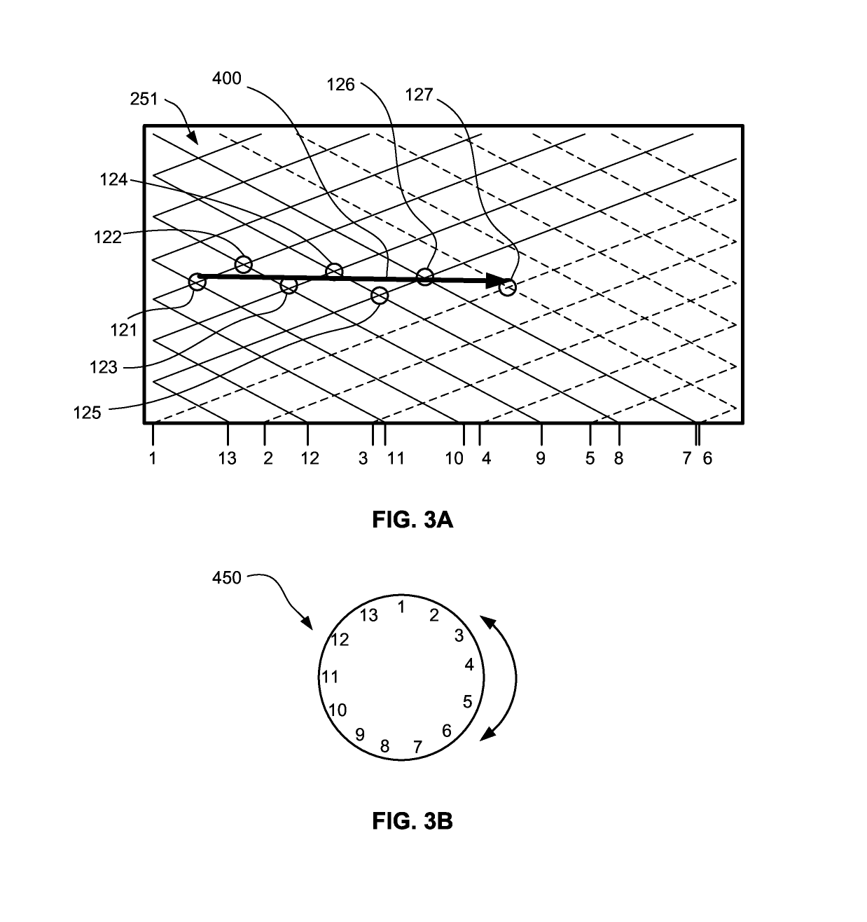

Reference is now made to FIGS. 3A and 3B showing simplified schematic drawings identifying exemplary junctions of an exemplary grid pattern of a digitizer sensor receiving input and a numbering system for tracking movement across the digitizer sensor based on the inputs, all in accordance with some embodiments of the present disclosure. As an object moves across a sensor pattern 251 over a path 400, changes in capacitive coupling are detected at junctions near path 400. The object can be a fingertip or other object that capacitively couples with sensor pattern 251. Optionally, the object is a stylus or other object that emits a signal and sensor pattern 251 picks up the signal. For example, changes in capacitive coupling indicating interaction are detected at junctions 121, 122, 123, 124, 125, 126 and 127. Optionally, antennas in array 154 are numbered in a consecutive ascending order from 1 to N, where N is the number of antennas in array 154 and antennas in array 156 are numbered in consecutive descending order from N−1 to 1. Optionally, numbering the antennas in such a manner provides intuitive coordinates for junctions, e.g. junctions 121-127. When using such a convention, junction 121 is defined by coordinates (10, 11), junction 122 is defined by coordinates (9, 11), junction 123 is defined by coordinates (9, 12), junction 124 is defined by coordinates (8, 12), junction 125 is defined by coordinates (8, 13), junction 126 is defined by coordinates (7, 13) and junction 127 is defined by coordinates (6, 1). In this manner coordinates following horizontal path 400 have a smooth slope. This convention also provides the same type of intuitive coordinates for movement in a vertical direction. Referring now to FIG. 3B, a dial representation 450 of coordinate labeling demonstrates how the coordinates change with movement in direction 400. In response to horizontal movement, for example, the first coordinate of the pair will advance in a counter-clock wise direction while the second coordinate will advance in a clockwise direction.

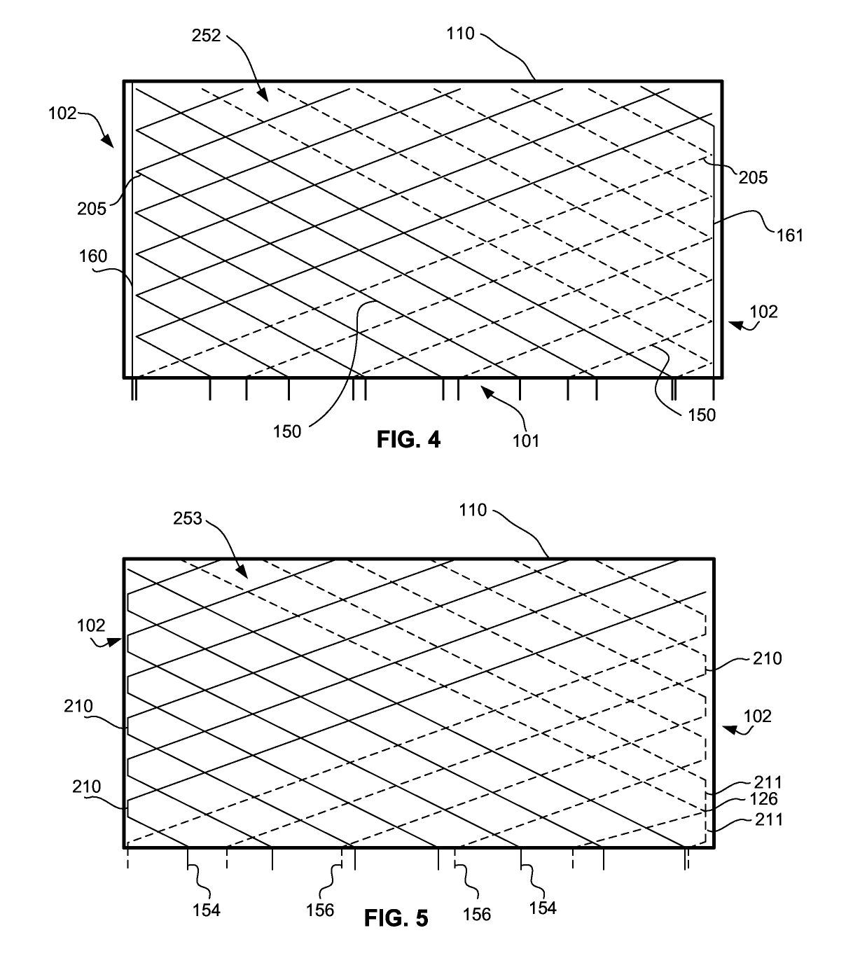

Reference is now made to FIG. 4 showing a simplified schematic drawing of an exemplary grid pattern including sensing lines that improve resolution near edges of the sensing area in accordance with some embodiments of the present disclosure. In some exemplary embodiments, a sensor pattern 252 includes a plurality of diagonally extending antennas that reflect off edges 102 and also includes additional antenna 160 and 161 that generally extend along edges 102 to add additional junctions near the edges 102. By adding antennas 160 and 161, bends 205 operate as junctions and input at bends 205 can be detected based on capacitive coupling between each of bends 205 and antennas 160 or 161. Optionally, antenna 161 can also include a bend and add resolution at the corners of sensing area 110. Optionally, since each of antennas 160 and 161 form junctions with a different set of antennas, antenna 160 and antenna 161 can be connected and operate as a single antenna.

Reference is now made to FIG. 5 showing a simplified schematic drawing of an exemplary diagonal grid pattern with improved resolution along edges in accordance with some embodiment of the present disclosure. Optionally, resolution near edges 102 is improved by forming truncating bends 210 along edges 102. The truncated portions extend parallel to edges 102. Truncating the bends increases proximity of the junctions to edges 102 so that touch can be detected near the edges. Alternatively, some or all the truncated portions, e.g. truncated portions 211 can be brought in proximity to one another to form a junction 126 between them.

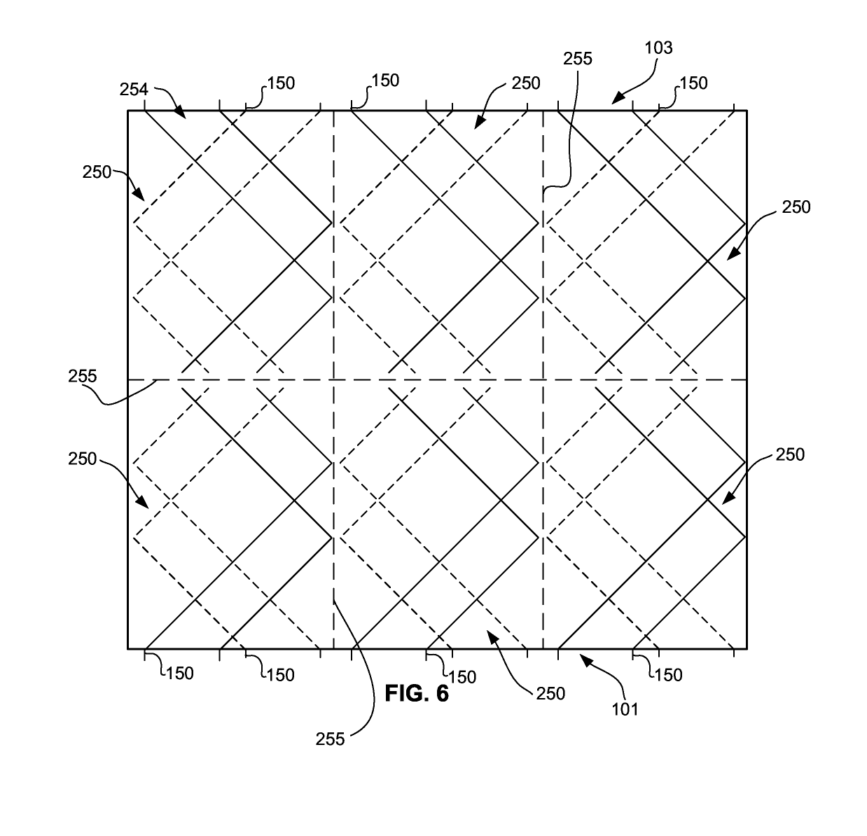

Reference is now made to FIG. 6 showing a simplified schematic drawing of an exemplary grid pattern formed from a plurality of independent sensing sections in accordance with some embodiments of the present disclosure. According to some embodiments of the present disclosure, a sensing pattern 250 is repeated to form a larger sensing pattern 254. Alternatively, different sensing patterns may be used to form larger sensing pattern 254. Typically, at least a portion of the sensing patterns are formed with antennas that extend from a same edge so that other sensing patterns can be positioned around the three other edges of the sensing pattern.

Optionally, the sensing patterns are aligned and proximity between the sensing patterns 250 can be defined so that sensing junctions are formed along partitions 255, e.g. virtual partitions between patterns 250 so that junctions can be formed between the patterns. Optionally, the sensing patterns may be aligned to connect to one another. Each of patterns 250 may be operated separately to detect input over a defined area or the patterns 250 may be operated simultaneously to detect input over the entire sensing area. This arrangement can be used to form a large sensing area without compromising measurement accuracy and increasing power demand to accommodate substantially longer antennas. Such arrangement provides a modular solution with a multiplicity of form factors using a limited number of building blocks.

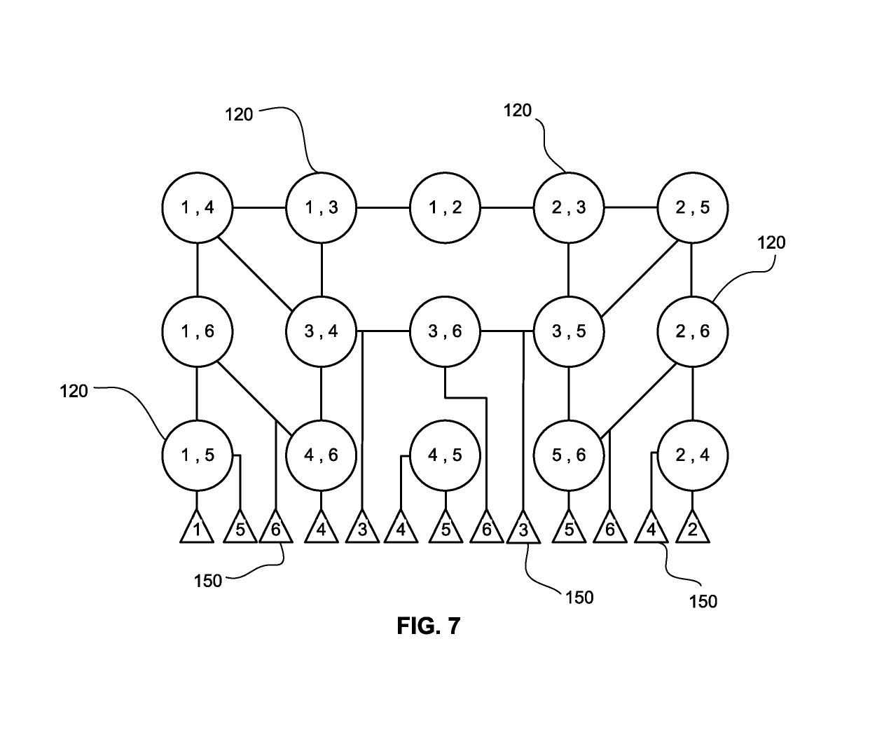

Reference is now made to FIG. 7 showing a schematic illustration of exemplary junctions for a grid pattern of a digitizer sensor in accordance with some embodiments of the present disclosure. Although most of the sensor patterns described in the present disclosure are formed from diagonal antennas that extend toward an edge and then bend, other patterns can be defined where each antenna crosses most or all other antennas once so that the number of antennas in relation to the number of junctions may be optimized. In the example shown in FIG. 7, 15 junctions are formed with only 6 antennas and each antenna crosses with all other antennas once. Different patterns may be formed to define the junctions as shown in FIG. 7.

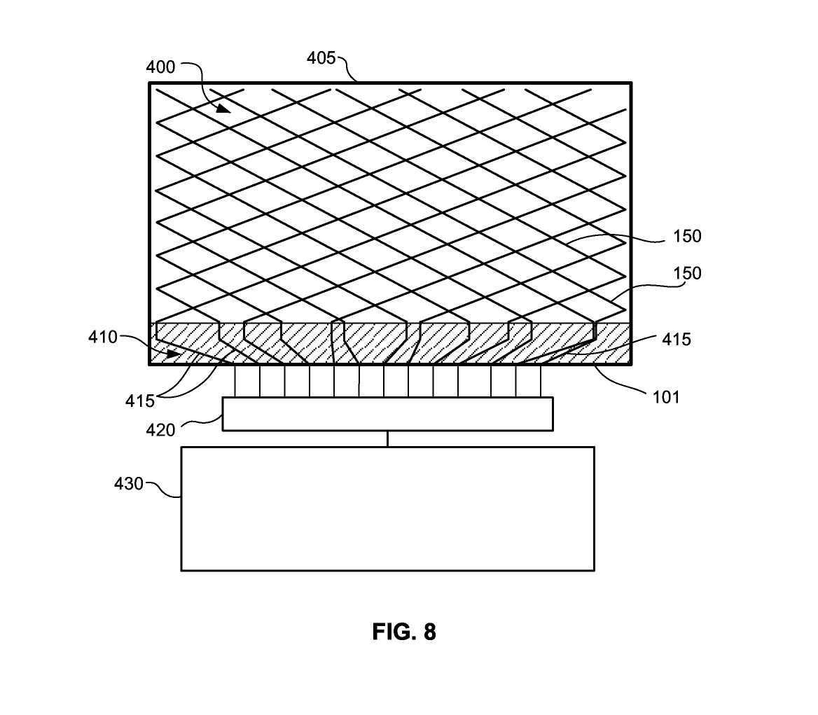

Reference is now made to FIG. 8 showing a simplified block diagram of a digitizer system in accordance with some embodiments of the present disclosure. According to some embodiments of the present disclosure, an electronic display is integrated with a grid based capacitive sensor 400. In some exemplary embodiments, each of the antennas 150 extend from one edge 101 and connect to metal traces 415 on display 405. Typically, black print 410 is used to cover an area including metal traces 415. Typically, metal traces 415 connect to circuit 420 including an application specific circuit (ASIC) or a printed circuit board (PCB) including one or more ASICS. Circuit 420 controls and operates sensor 400. Output from sensor 400 is typically reported to host 430. Optionally, host 430 communicates with circuit 420 and provides commands for operating sensor 400. Typically, a digitizer system includes sensor 400 together with circuit 420. Optionally, some or all functionality of circuit 420 is integrated into host 430.

According to some embodiments of the present disclosure, sensor 400 together with circuit 420 is operated to track input by one or more fingers, styluses, conductive objects and dielectric objects. Typically, sensor 400 can detect both touch and hover of the objects. In some exemplary embodiments, sensor 400 is a transparent sensor and antennas 150 are optionally formed from indium tin oxide (ITO).

An aspect of some embodiments provides for a sensor including a sensing area confined by a plurality of edges; and a plurality of antennas spread across the sensing area and that cross each other to form a grid of junctions, wherein the grid of junctions includes H*V junctions and wherein the plurality of antennas includes less than H+V antennas, wherein H is an integer number and V is an integer number.

Optionally, the plurality extends from only one of the edges of the sensing area.

Optionally, the plurality cross each other only once.

Optionally, at least one of the plurality of antennas crosses all other of the plurality of antennas.

Optionally, the number of junctions formed from the plurality of antennas is greater than (N/2)̂2, wherein N is the number of the plurality of antennas.

Optionally, a first portion of the plurality of antennas extend diagonally from one edge toward a first neighboring edge and a second portion of the plurality of antennas extend diagonally from the one edge toward a second neighboring edge.

Optionally, a length of the one edge is X and a length of the first neighboring edge is Y and wherein the angle between a diagonally extending antenna from the plurality and the one edge either equals or is greater than an arctangent(Y/X).

Optionally, the first portion extends toward the first neighboring edge and then continues to extend away from the first neighboring edge and wherein the second portion extends toward the second neighboring edge and then continues to extend away from the second neighboring edge.

Optionally, antennas from the first portion forms junctions with antennas from the second portion and the first portion.

Optionally, the plurality of antennas include a first antenna extending along the first neighboring edge and forming junctions with the first portion.

Optionally, the first portion partially extends along the first neighboring edge.

Optionally, the plurality of antennas are patterned on a single layer.

Optionally, the sensor is configured to sense based on at least one of mutual capacitive detection or self-capacitive detection.

Optionally, the sensor is configured to sense input from an object that interacts with the sensor and emits a signal.

Optionally, the sensor includes a plurality of distinct sensing areas, wherein the sensing area is one of the plurality of distinct sensing areas.

Optionally, a portion of the junctions of the sensor are formed between two of the plurality of sensing areas.

Optionally, the sensing area is configured to be operated independently from other sensing areas of the plurality.

An aspect of some embodiments provides for device including: a sensor with a sensing area confined by a plurality of edges and a plurality of antennas spread across the sensing area and that cross each other to form a grid of junctions, wherein the grid of junctions includes H*V junctions and wherein the plurality of antennas includes less than H+V antennas, wherein H is an integer number and V is an integer number, wherein the plurality extends from a first edge of the sensing area; and a circuit configured to connect to each of the plurality of antennas along the first edge.

Optionally, a first portion of the plurality of antennas extend diagonally from the first edge toward a first neighboring edge of its sub-area and then continues to extend away from the first neighboring edge and a second portion of the plurality of antennas extend diagonally from the first edge toward a second neighboring edge of its sub-area and then continues to extend away from the second neighboring edge.

Optionally, the device includes a plurality of sensors positioned side by side and defining a larger sensing area, wherein the first edge of each of the plurality of sensors extends along a portion of a perimeter of the larger sensing area.

Optionally, the device is configured to sense input from a signal-emitting object interacting with the sensor.

Certain features of the examples described herein, which are, for clarity, described in the context of separate embodiments, may also be provided in combination in a single embodiment. Conversely, various features of the examples described herein, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

What is claimed is:

1. A sensor comprising:
a sensing area confined by a plurality of edges;
a plurality of antennas spread across the sensing area and that cross each other to form a grid of junctions, wherein the grid of junctions includes H*V junctions and wherein the plurality of antennas includes less than H+V antennas, wherein H is an integer number and V is an integer number.

2. The sensor of claim 1, wherein the plurality extends from only one of the edges of the sensing area.

3. The sensor of claim 1, wherein the plurality cross each other only once.

4. The sensor of claim 1, wherein at least one of the plurality of antennas crosses all other of the plurality of antennas.

5. The sensor of claim 1, wherein the number of junctions formed from the plurality of antennas is greater than (N/2)̂2, wherein N is the number of the plurality of antennas.

6. The sensor of claim 1, wherein a first portion of the plurality of antennas extend diagonally from one edge toward a first neighboring edge and a second portion of the plurality of antennas extend diagonally from the one edge toward a second neighboring edge.

7. The sensor of claim 6, wherein a length of the one edge is X and a length of the first neighboring edge is Y and wherein the angle between a diagonally extending antenna from the plurality and the one edge either equals or is greater than an arctangent(Y/X).

8. The sensor of claim 6, wherein the first portion extends toward the first neighboring edge and then continues to extend away from the first neighboring edge and wherein the second portion extends toward the second neighboring edge and then continues to extend away from the second neighboring edge.

9. The sensor of claim 6, wherein antennas from the first portion forms junctions with antennas from the second portion and the first portion.

10. The sensor of claim 6, wherein the plurality of antennas include a first antenna extending along the first neighboring edge and forming junctions with the first portion.

11. The sensor of claim 6, wherein the first portion partially extends along the first neighboring edge.

12. The sensor of claim 1, wherein the plurality of antennas are patterned on a single layer.

13. The sensor of claim 1, wherein the sensor is configured to sense input from an object that interacts with the sensor and emits a signal.

14. The sensor of claim 1, comprising a plurality of distinct sensing areas, wherein the sensing area is one of the plurality of distinct sensing areas.

15. The sensor of claim 14, wherein a portion of the junctions of the sensor are formed between two of the plurality of sensing areas.

16. The sensor of claim 14, wherein the sensing area is configured to be operated independently from other sensing areas of the plurality.

17. A device comprising:
a sensor comprising:
a sensing area confined by a plurality of edges;
a plurality of antennas spread across the sensing area and that cross each other to form a grid of junctions, wherein the grid of junctions includes H*V junctions and wherein the plurality of antennas includes less than H+V antennas, wherein H is an integer number and V is an integer number, wherein the plurality extends from a first edge of the sensing area; and
a circuit configured to connect to each of the plurality of antennas along the first edge.

18. The device of claim 17, wherein a first portion of the plurality of antennas extend diagonally from the first edge toward a first neighboring edge of its sub-area and then continues to extend away from the first neighboring edge and a second portion of the plurality of antennas extend diagonally from the first edge toward a second neighboring edge its sub-area and then continues to extend away from the second neighboring edge.

19. The device of claim 17, comprising a plurality of sensors positioned side by side and defining a larger sensing area, wherein the first edge of each of the plurality of sensors extends along a portion of a perimeter of the larger sensing area.

20. The sensor of claim 17, wherein the device is configured to sense input from a signal-emitting object interacting with the sensor.
